(19) United States
(12) Patent Application Publication
(10) Pub. No.: US 2020/0207543 A1
(43) Pub. Date: Jul. 2, 2020

(54) WASTE CONTAINMENT AND DISPOSAL SYSTEM

(71) Applicant: Jen-Lung David Tai, Scottsdale, AZ (US)

(72) Inventor: Jen-Lung David Tai, Scottsdale, AZ (US)

(21) Appl. No.: 16/235,721

(22) Filed: Dec. 28, 2018

(51) Int. Cl. B65F 1/14; B09B 1/00; B65F 1/16; B65F 1/00

(52) U.S. Cl. CPC B65F 1/1415; B09B 1/00; B65F 2210/188; B65F 1/0006; B65F 1/16

(57) ABSTRACT

A system for containing and disposing solid waste includes a container and a structure for supporting the container. The container has an opening attachable to the structure. The structure includes vacuum ports, a heating element, and may have an air-tight sealing device or material. The container is attached to the structure, waste is placed inside of it, the container is sealed, vacuum removes gas from the container, and the container is then sealed a second time using heat.

### FIELD

The invention relates to systems and methods for containing, transporting and/or disposing solid waste.

### BACKGROUND

Storing and disposing of solid waste, such as human excrement, is cumbersome and difficult, especially when away from home. For example, when traveling in a recreational vehicle, a national park, or anywhere there are not toilet facilities, it may not be desirable or permissible to leave excrement in the area, or fluid tank capacity for portable, chemical tanks is limited (such as in a recreational vehicle).

### SUMMARY

This disclosure defines systems and methods for containing, transporting and/or disposing solid waste, such as human excrement. The system includes a waste container (or “container”), a support structure (or “support”) to which the container can be attached, a control, and a pump. The container is preferably a bag comprised of biodegradable plastic and has an inner cavity, one end that can be opened to access the inner cavity, or closed by an air-tight seal. As used herein, “air-tight” means substantially air tight under the conditions in which the container is used.

The support has a first position and a second position. When the container is attached to the support and the support is in its first position the container is in an open position. When the support moves to the second position the container is moved to a closed position. When in the closed position a first air-tight seal is formed along an outer perimeter of the container opening.

The support further includes (1) one or more vacuum ports in communication with the container inner cavity, and (2) a heating element. When the support moves to its second position, the container opening is closed and the first air-tight seal is formed on the outer perimeter of the container opening. The one or more vacuum ports are inside of the first air-tight seal and an air-tight seal is formed between each of the one or more ports and the material forming the container, so each vacuum port extends into the container inner cavity. The heating element is positioned inside of the one or more vacuum ports. As used herein, “inside of” with respect to the position of the one or more vacuum ports and the heating element means closer to the closed end of the container that is opposite the open end that is sealed according to aspects of this disclosure.

The one or more vacuum ports draw air and other gas from the container cavity when the pump is activated by the control. With the vacuum still on, the heating element is activated to heat seal the container at an inner perimeter, which is inside of the one or more vacuum ports.

Then the sealed container is removed from the structure and can be stored in any suitable storage container or area.

The support structure could be portable, or permanently attached to another structure, such as a toilet.

### BRIEF DESCRIPTION OF THE DRAWINGS

FIG. 1 is a front, partially collapsed view of a container in accordance with this disclosure.

FIG. 2 is a close-up view of the container of FIG. 1.

FIG. 3 is a rear view of the container of FIG. 1.

FIG. 4 is a top view of a support structure of a system according to this disclosure.

FIG. 4A is a top view of the support structure FIG. 4.

FIG. 5 is a side, perspective view of the support structure of FIG. 4.

FIG. 6 is a close-up, partial top view of the support structure of FIG. 4 with the lid open.

FIG. 7 is an alternate, partial top view of the support structure of FIG. 4 with the lid open.

FIG. 8 is an alternate, partial top view of the support structure of FIG. 4 with the lid open.

FIG. 9 is a side view of the support structure of FIG. 4 with the lid in the closed position.

FIG. 10 is an alternate view of the support structure of FIG. 4 with the lid in the closed position.

FIG. 11 is a top, perspective view of the support structure of FIG. 4 with the lid in its open position.

FIG. 12 is a side, perspective view of the support structure of FIG. 4 with the second section pivoting.

FIG. 13 is a side, perspective view of the support structure of FIG. 4 with the second section pivoting with the second section adjacent the first section.

FIG. 14 shows a power pack with battery and controls.

### DETAILED DESCRIPTION OF PREFERRED EMBODIMENTS

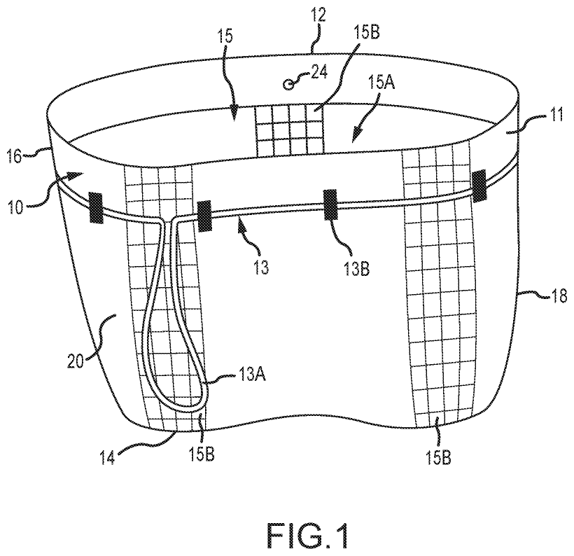

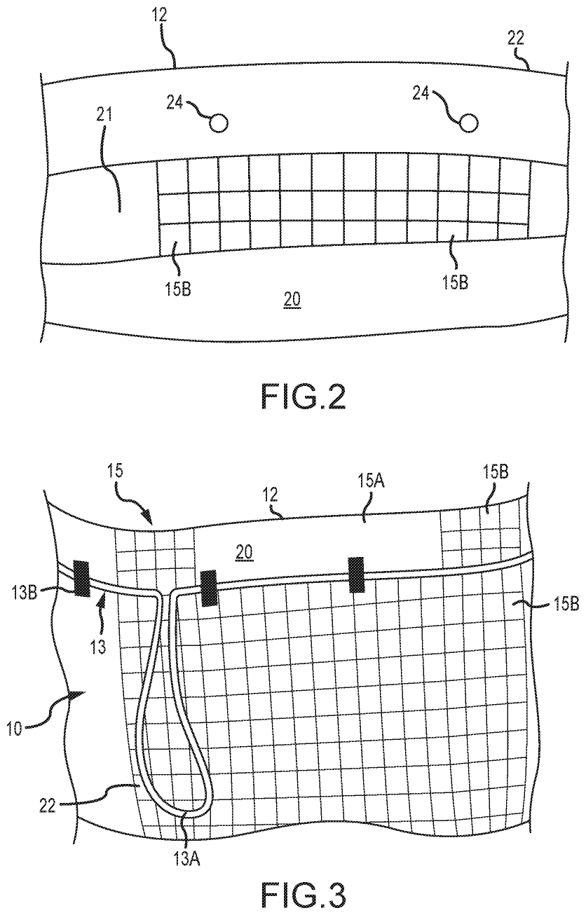

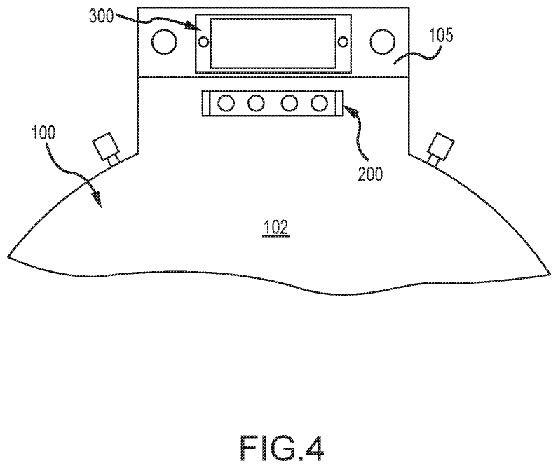

Turning now to the figures, where the purpose is to describe embodiments of this disclosure and not to limit the scope of the claims, FIG. 1 shows a front, partially collapsed view of a container 10 in accordance with this disclosure.

Container 10 is preferably a flexible bag comprised of biodegradable plastic, although any suitable container made of any suitable material would suffice. Container 10 has an outer surface 11, an open end 12, a closed end 14 opposite open end 12, inner cavity 15, an interior surface 15A, and closed sides 16, 18. Open end 12 may have a fastening system 13 that can mechanically close open end 12, or open end 12 may simply be open. The mechanical fastening system 13 as shown includes a drawstring 13A, and loops 13B that are connected to outer surface 11. At least some of the material of which inner surface 15A is comprised may be embossed, such as in waffle pattern 15B, so the inner surface 15A is more prone to not completely collapse, and thus permit gas to be removed from inner cavity 15 when vacuum is applied.

Container 10 as shown has one or more openings 24 in side 22 that are used to connect to structure 100 by one or more vacuum ports 120, as explained further below. Container 100 also has outer tabs 26 configured to connect to tabs 109 on structure 100.

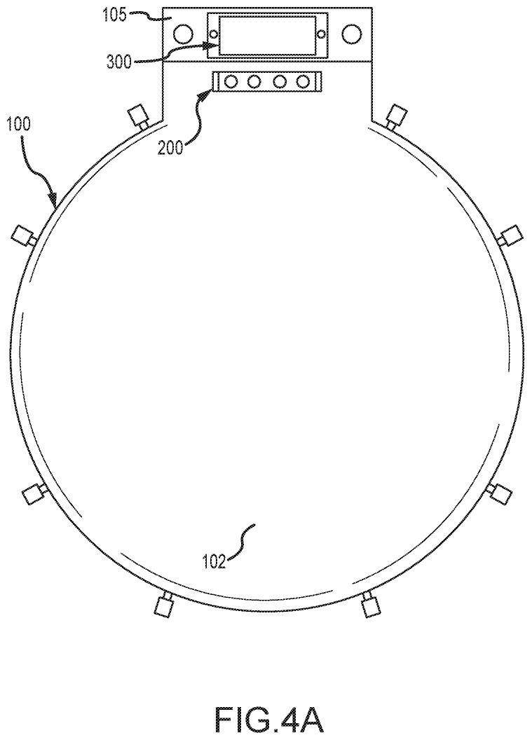

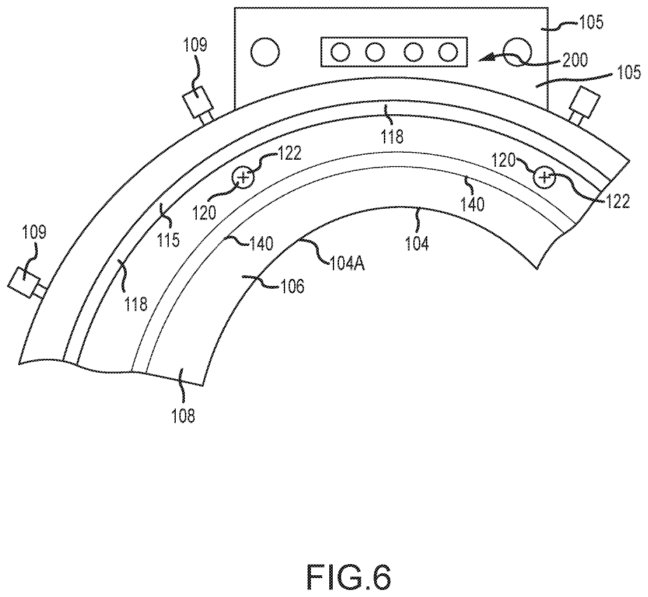

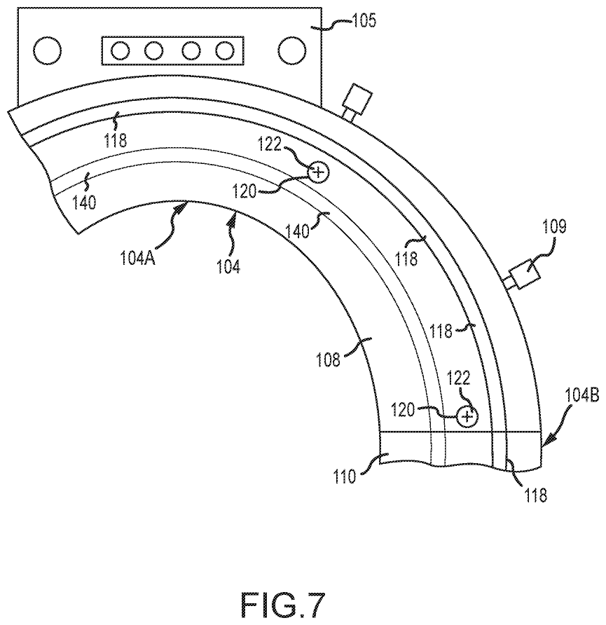

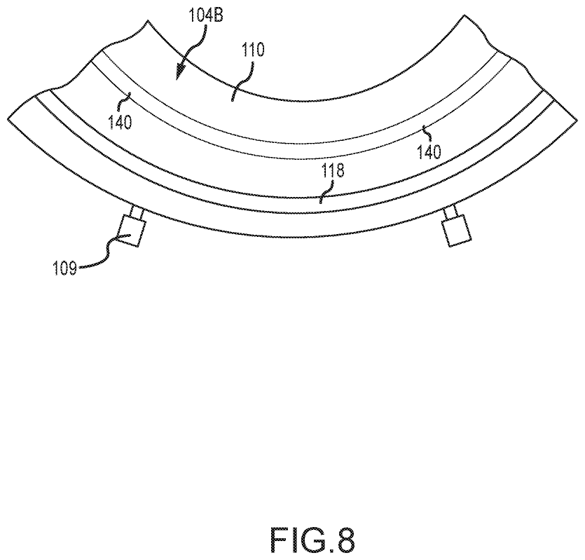

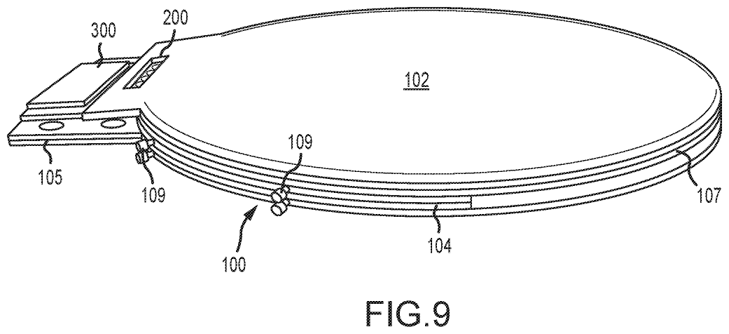

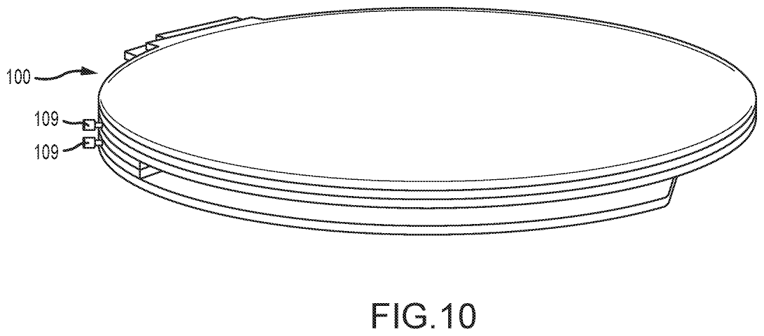

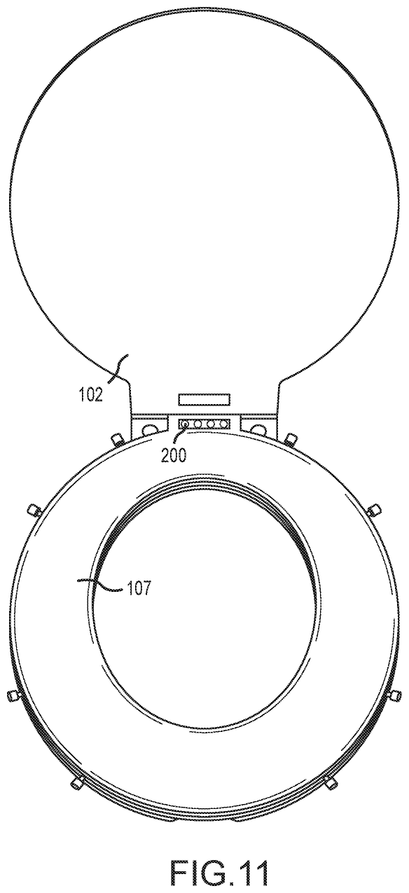

FIGS. 4-12 show a support structure 100. Structure 100 as shown has a lid 102 (which is optional), an attachment section 104, and a seat 107. Lid 102 as shown has the same basic shape and size as a standard toilet bowl lid, but (if used) could be any suitable shape or size. Seat 107 is preferably about the same size and shape as a standard toilet seat, but could be of any suitable shape or size.

Structure 100 may comprise any suitable material such as plastic and/or metal. Structure 100 may be portable, so it can be placed on any vessel (such as a toilet, drum, or bucket) or any other structure. Preferably, structure 100 is configured so that it weighs about 4-10 lbs., or 10 lbs. or less, or 8 lbs. or less, or 6 lbs. or less, or 5 lbs. or less.

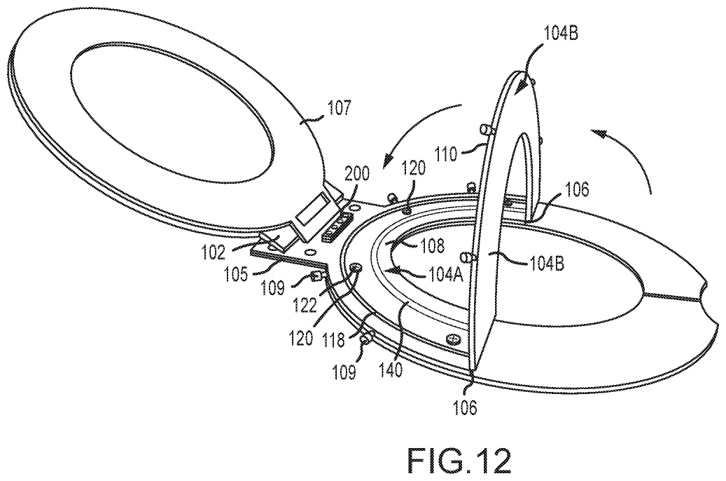

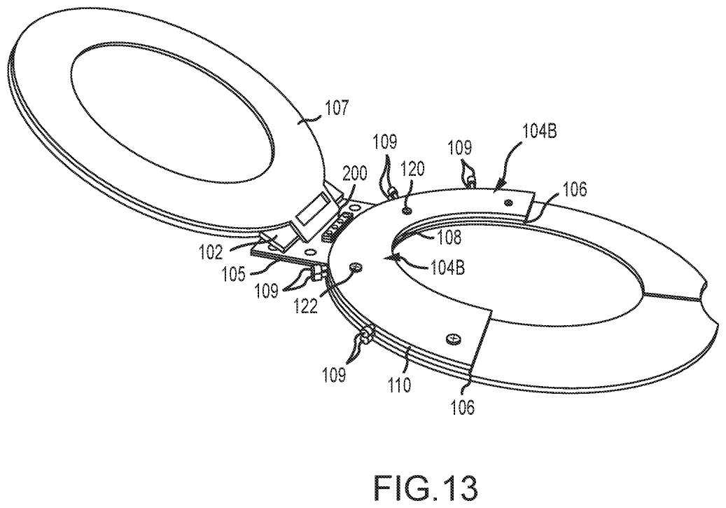

The attachment section 104 has a first part 104A with an upper surface 108, a second part 104B with an upper surface 110, and a neck portion 105. Attachment section 104 is configured so that second part 104B can move upwards and over (as shown in FIGS. 12-13) to contact first part 104A. Part 104A can be connected to part 104B in any suitable manner, and part 104B can be lifted and pivoted (as shown in FIG. 12) so its top surface 110 can be pressed against top surface 108 of section 104A. Any suitable structure, such as a hinge or flexible plastic, could be used as structure 106 to connect part 104A and 104B and permit the movement as described herein.

Structure 104 preferably includes a base 104C that rests upon and may surround the top opening of a vessel, such as a toilet, bucket, or drum, on which structure 104 is supported while in use.

Included in attachment section 104 is an outer sealing perimeter 118 on parts 104A, 104B, one or more vacuum ports 120 on part 104A, a heating element 140 on part 104A, and a compression section 150 on part 104B. Outer sealing perimeter 118 can be any structure or material capable of pressing sides 20, 22 of container 10 together at open end 12 in order to form an air-tight seal. For example, outer sealing perimeter 118 on section 104A and section 104B may be a raised material, such as a rubber gasket, that aligns and presses against sides 20, 22 of container 10 when surface 110 of second part 104B is pressed against a side 20, 22 when surface 110 of second part 104B is closely juxtaposed surface 108 of first part 104A.

There are one or more, and, as shown, there are four vacuum ports 120 equally, radially spaced around the perimeter of surface 108 of part 104A. Each vacuum port 120 preferably includes a raised button or tab 122 that extends above the top surface 108 of part 104A. Each tab 122 is configured to be attached to an opening 24 on side 22 of container 10. This method of attachment holds the container 10 to structure 100, and also permits vacuum ports 120 to draw out gas from inner cavity 15.

Supports 109, which may be hooks, bars or any suitable structure for connecting to tabs 26 of container 10 are on the outside of structure 104.

A heating element 140 is any device or structure that can heat the material of container 10 in order to melt and join the material at end 12 and create an air-tight seal. Heating element 140 is inside of the one or more vacuum ports 120 on first part 104A, which means it is closer to the center of structure 104 the vacuum ports 120. Preferably, heating element 140 is a metal strip connected to a source of electricity. A compression section 150 is preferably made of rubber or semi-hard elastomer that is not substantially degraded by the heat from heating element 140. As shown, compression section 150 on part 104B aligns with and compresses against one side 20 or 22 of container 10 when part 104A and part 104B are closely juxtaposed, as described above. Heating element 140 on part 104A is then against the other side 20 or 22 of container 10. When heating element 140 is activated it melts at least the side of container 10 that it touches, and perhaps the other side as well, causing an airtight seal to be formed by the melt that connects sides 20, 22. Alternatively, heating element 140 could on part 104A and 104B, and melt the material of container 10 from both sides and cause an airtight seal to form.

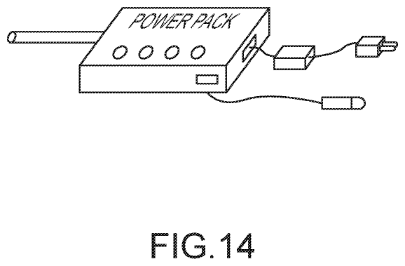

A control 200 as shown is mounted on front plate 105 of first part 104A of attachment section 104. Control 200 has one or more buttons operational to (1) turn power on or off, (2) operate an air pump (not shown) to create vacuum through vacuum ports 120, (3) operate heating element 140, and (4) turn off the air pump to release the vacuum. Alternatively, control 200, or any part of it, may be remote to structure 100. For example and as shown in FIG. 14, the control for the vacuum may be connected to the pump (not shown) that creates the vacuum.

Power may be provided in any manner, such as by power source 300. The power may be a battery pack, or a cord connectable to a standard AC electrical outlet or to a vehicle DC electrical outlet. Structure 100 could be configured to work with different types of power provided from different sources, such as standard home electricity, electricity from a vehicle, and electricity from a battery source. The power source may be separate from structure 100 and not physically connected to it.

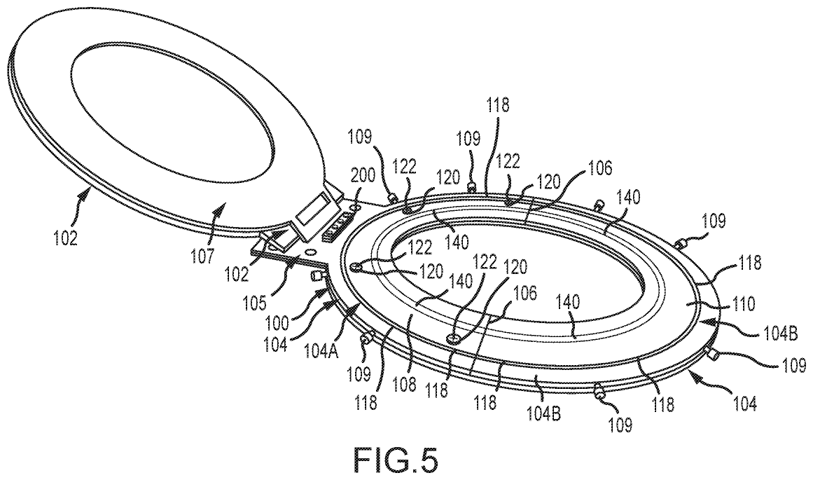

In use, structure 100 may first be positioned on a vessel (not shown), such as by placing base 104C on the rim of an open edge of the vessel. A container 10 is attached in an open position onto structure 100 by positioning openings 24 onto buttons 122 and tabs 26 onto supports 109. When container 10 is positioned on structure 100, structure 100 is in its first position with part 104A and part 104B generally side-by-side as shown, for example, in FIG. 5, and container 10 is in its open position. Solid waste is then placed through open end 12 into inner cavity 15 of the container 10. The structure 100 is then moved to its second position, whereby part 104B pivots upward and over, as shown in FIGS. 12-13, until surface 110 presses against, or is closely juxtaposed, surface 108. A clamp (not shown), or lid 107, or other structure, may be closed to hold part 104B against part 104A. Outer sealing perimeter 118 presses against sides 20, 22 of container 10 at open end 12, which moves the container 10 to its closed position, with outer perimeter 118 creating an air-tight seal. Compression section 140 presses container 10 against heating element 120.

Using control 200, a vacuum is then applied by the air pump (not shown) to the inner cavity 15 of container 10 to remove air and other gas. With the vacuum on, or after the vacuum is turned off, the control 200 is operated to activate heating element 140 to melt the material of container 10 until an airtight seal is created between sides 20, 22 of the container 10. This airtight seal is inside of the outer sealing perimeter 118 and inside of the vacuum ports 130.

The container 10 is then removed from the structure 100 and disposed or stored.

Chemicals to control bacteria growth and/or seeds or other materials may be included in container 10 before or after the solid waste is added. So many chemicals to kill bacteria.

Some non-limiting, exemplary embodiments of the disclosure follow:

A system for waste containment, the system comprising:
container having an opening with an outer perimeter, an inner cavity, and an open position in which waste can be placed into the inner cavity, and a closed position in which it is air tight;
a pump in fluid communication with the container, the pump configured to pump gas out of the inner cavity of the container; and
a control unit with an on switch that turns the pump on and an off switch that turns the pump off.

The system of claim 1 that further includes a vessel including cavity, an opening, and an outer perimeter around the opening, wherein the container attaches to the outer perimeter.

The system of claim 2, wherein the vessel further comprises a lid that has a first position in which it does not press against the outer perimeter and a second position in which it does not press against the outer perimeter.

The system of claim 3, wherein the container is attached to the lid.

The system of claim 4, wherein the container is in its first position when the lid is in its first position and the container is in its second position when the lid is in its second position.

The system of claim 1, wherein the container is degradable and flexible.

The system of claim 3, wherein the lid is attached to the vessel.

The system of claim 7, wherein the lid is attached to the vessel by a hinge.

The system of claim 1 that further comprises a heating element configured to melt a material of the container, the heating element in communication with the control, and the heating element having a first mode in whit it is not hot enough to melt the material of the container and a second mode in which it is hot enough to melt the material of the container.

The system of claim 4, wherein a first part of the container perimeter is attached to the lid and a second part of the container perimeter is connected to the outside perimeter of the vessel.

The system of claim 10 that further includes one or more vacuum ports in communication with the container cavity.

The system of claim 11, wherein there is a plurality of vacuum ports.

The system of claim 1, wherein the container has a mechanical air-tight seal.

The system of claim 14, wherein the mechanical air-tight seal comprises a rib received in a groove.

The system of claim 14, wherein a first half of the container perimeter includes a rib and a second half of the container perimeter includes a groove.

The system of claim 2, wherein the control unit is on the vessel.

The system of claim 11, wherein the vacuum ports are on the vessel.

The system of claim 9, wherein the heating element is on the vessel.

The system of claim 18, wherein the vacuum ports are on the vessel.

The system of claim 19, wherein the vacuum ports are outside of the heating element.

The system of claim 1 that is self-contained and portable.

The system of claim 1, wherein the motor is separate.

A method of containing solid waste, the method comprising the steps of:
positioning a container in an open position onto a structure, wherein the structure is in its first position;
placing solid waste through an opening and into an inner cavity of the container;
moving the structure to a second position, which moves the container to a second position and creates an air tight seal along an outer perimeter of the container;
applying a vacuum to the inner cavity to remove gas; heat sealing an inner perimeter of the container, the inner perimeter inside of the outer perimeter.

The method of claim 23 that further includes the step of removing the container from the structure, after the heat sealing.

The method of claim 23, wherein the structure folds from the first position into the second position.

The method of claim 23, wherein a control activates the vacuum.

The method of claim 23, wherein a control activates a heating element that performs the heat sealing.

The method of claim 23, wherein the structure weighs less than 10 lbs.

The method of claim 23, wherein the structure weighs less than 5 lbs.

The method of claim 23, wherein the container is attached to the structure by tabs.

The method of claim 30, wherein the tabs are positioned around a perimeter of the structure.

The method of claim 30, wherein there are vacuum ports inside of the tabs.

The method of claim 30, wherein the structure further includes a heating element that is inside of the tabs.

The method of claim 26, wherein the control is connected to the structure.

The method of claim 23, wherein the structure further includes a power source.

The method of claim 23 that further includes a lid and a seat.

The method of claim 23 that further includes the step of positioning the structure or a vessel before placing solid waste into the container.

Having thus described different embodiments, other variations and embodiments that do not depart from the spirit of this disclosure will become apparent to those skilled in the art. The scope of the claims is thus not limited to any particular embodiment, but is instead set forth in the claims and the legal equivalents thereof. Unless expressly stated in the written description or claims, the steps of any method recited in the claims may be performed in any order capable of yielding the desired product. No language in the specification should be construed as indicating that any non-claimed limitation is included in a claim. The terms “a” and “an” in the context of the following claims are to be construed to cover both the singular and the plural, unless otherwise indicated herein.

What is claimed is:

1. A system for waste containment, the system comprising:
(a) container having an opening with an outer perimeter, an inner cavity, and an open position in which waste can be placed into the inner cavity, and a closed position in which it is air tight;
(b) a pump in fluid communication with the container, the pump configured to pump gas out of the inner cavity of the container; and
(c) a control unit with an on switch that turns the pump on and an off switch that turns the pump off.

2. The system of claim 1 that further includes a vessel including cavity, an opening, and an outer perimeter around the opening, wherein the container attaches to the outer perimeter.

3. The system of claim 2, wherein the vessel further comprises a lid that has a first position in which it does not press against the outer perimeter and a second position in which it does not press against the outer perimeter.

4. The system of claim 3, wherein the container is attached to the lid.

5. The system of claim 4, wherein the container is in its first position when the lid is in its first position and the container is in its second position when the lid is in its second position.

6. The system of claim 1, wherein the container is degradable and flexible.

7. The system of claim 3, wherein the lid is attached to the vessel.

8. The system of claim 7, wherein the lid is attached to the vessel by a hinge.

9. The system of claim 1 that further comprises a heating element configured to melt a material of the container, the heating element in communication with the control, and the heating element having a first mode in whit it is not hot enough to melt the material of the container and a second mode in which it is hot enough to melt the material of the container.

10. The system of claim 4, wherein a first part of the container perimeter is attached to the lid and a second part of the container perimeter is connected to the outside perimeter of the vessel.

11. The system of claim 10 that further includes one or more vacuum ports in communication with the container cavity.

12. The system of claim 11, wherein there is a plurality of vacuum ports.

13. The system of claim 1, wherein the container has a mechanical air-tight seal.

14. The system of claim 14, wherein the mechanical air-tight seal comprises a rib received in a groove.

15. The system of claim 14, wherein a first half of the container perimeter includes a rib and a second half of the container perimeter includes a groove.

16. The system of claim 2, wherein the control unit is on the vessel.

17. The system of claim 11, wherein the vacuum ports are on the vessel.

18. The system of claim 9, wherein the heating element is on the vessel.

19. The system of claim 18, wherein the vacuum ports are on the vessel.

20. The system of claim 19, wherein the vacuum ports are outside of the heating element.

21. The system of claim 1 that is self-contained and portable.

22. The system of claim 1, wherein the motor is separate.

23. A method of containing solid waste, the method comprising the steps of:
(a) positioning a container in an open position onto a structure, wherein the structure is in its first position;
(b) placing solid waste through an opening and into an inner cavity of the container;
(c) moving the structure to a second position, which moves the container to a second position and creates an air tight seal along an outer perimeter of the container;
(d) applying a vacuum to the inner cavity to remove gas; heat sealing an inner perimeter of the container, the inner perimeter inside of the outer perimeter.

24. The method of claim 23 that further includes the step of removing the container from the structure, after the heat sealing.

25. The method of claim 23, wherein the structure folds from the first position into the second position.

26. The method of claim 23, wherein a control activates the vacuum.

27. The method of claim 23, wherein a control activates a heating element that performs the heat sealing.

28. The method of claim 23, wherein the structure weighs less than 10 lbs.

29. The method of claim 23, wherein the structure weighs less than 5 lbs.

30. The method of claim 23, wherein the container is attached to the structure by tabs.

31. The method of claim 30, wherein the tabs are positioned around a perimeter of the structure.

32. The method of claim 30, wherein there are vacuum ports inside of the tabs.

33. The method of claim 30, wherein the structure further includes a heating element that is inside of the tabs.

34. The method of claim 26, wherein the control is connected to the structure.

35. The method of claim 23, wherein the structure further includes a power source.

36. The method of claim 23 that further includes a lid and a seat.

37. The method of claim 23 that further includes the step of positioning the structure or a vessel before placing solid waste into the container.
